(19) United States
(12) Patent Application Publication
(10) Pub. No.: US 2008/0227403 A1
(43) Pub. Date: Sep. 18, 2008

(54) WIRELESS COMMUNICATION BASE STATION DEVICE AND WIRELESS COMMUNICATION METHOD ALLOWING USE OF PLURALITY OF COMMUNICATION SCHEMES

(76) Inventor: Daisuke TAKI, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/045,956

(22) Filed: Mar. 11, 2008

(30) Foreign Application Priority Data
Mar. 15, 2007 (JP) 2007-067283

(51) Int. Cl. H04B 7/005

(52) U.S. Cl. 455/68

(57) ABSTRACT

A wireless communication base station device uses first and second wireless communication schemes. The device includes a command transmitting section and a terminal detecting section. The command transmitting section generates a shift command for a shift from the first wireless communication scheme to the second wireless communication scheme. The command transmitting section transmits the shift command to a wireless communication terminal. The first wireless communication scheme uses a frequency bandwidth different from that used in the second wireless communication scheme. The terminal detecting section, after the transmission of the shift command, searches for a wireless communication terminal having failed to shift from the first wireless communication scheme to the second wireless communication scheme. The terminal detecting section, if the wireless communication terminal having failed in the shift is detected, instructs the command transmitting section to transmit the shift command again.

### CROSS-REFERENCE TO RELATED APPLICATIONS

This application is based upon and claims the benefit of priority from prior Japanese Patent Application No. 2007-067283, filed Mar. 15, 2007, the entire contents of which are incorporated herein by reference.

### BACKGROUND OF THE INVENTION

1. Field of the Invention

The present invention relates to a wireless communication base station device allowing the use of a plurality of communication schemes. For example, the present invention relates to a wireless LAN base station device.

2. Description of the Related Art

In recent years, the IEEE (Institute of Electrical and Electronics Engineers) 802.11 committee has been examining next-generation high-speed wireless LAN (Local Area Network) schemes. One of the schemes proposed by the committee increases the conventional communication frequency band of 20 MHz to 40 MHz to achieve faster communication. This proposal is disclosed in, for example, “IEEE Standards for Information Technology—Telecommunications and Information Exchange between Systems—Local and Metropolitan Area Network—Specific Requirements—Part 11: Wireless LAN Medium Access Control (MAC) and Physical Layer (PHY) Specifications”, IEEE 802.11, 1999 Edition (ISO/IEC 8802-11), 1999.

Furthermore, a function called a phased coexistence operation (hereinafter referred to as a PCO function) has been proposed which enables communication in both a 40-MHz band and a 20-MHz band by allowing one wireless LAN base station to simultaneously accommodate wireless LAN terminals for communication in the 40-MHz band and wireless LAN terminals for communication in the 20-MHz band. This proposal has been disclosed in “Draft STANDARD for Information Technology—Telecommunications and information exchange between systems—Local and metropolitan area networks—Specific requirements—Part 11: Wireless LAN Medium Access Control (MAC) and Physical Layer (PHY) specifications: Amendment <number>: Enhancements for Higher Throughput”, IEEE P802.11n/D2.00, February 2007. With the PCO function, the wireless LAN base station commands all the wireless LAN terminals accommodated by the wireless LAN base station to shift from the 20-MHz band communication to the 40-MHz band communication.

However, a wireless LAN terminal having failed to receive the shift command remains in the 20-MHz band communication status and cannot transmit or receive data during the 40-MHz band communication.

Furthermore, after the shift command, the wireless LAN base station transmits and receives data on the basis of the 40-MHz band communication. However, the wireless LAN base station does not recognize the presence of the wireless LAN terminal having failed to shift to the 40-MHz band communication. Thus, the wireless LAN base station also transmits data to the wireless LAN terminal having failed to shift to the 40-MHz band communication, on the basis of the 40-MHz band communication. Then, this wireless LAN terminal cannot correctly receive the data. The wireless LAN base station thus repeats transmitting the same data to the wireless LAN terminal. This reduces the band use efficiency of the whole system.

### BRIEF SUMMARY OF THE INVENTION

A wireless communication base station device allowing use of a first wireless communication scheme and a second wireless communication scheme, the device according to an aspect of the present invention includes:

a command transmitting section which generates a shift command for a shift from the first wireless communication scheme to the second wireless communication scheme and which transmits the shift command to a wireless communication terminal, the first wireless communication scheme using a frequency bandwidth different from that used in the second wireless communication scheme; and

a terminal detecting section which, after the transmission of the shift command, searches for a wireless communication terminal having failed to shift from the first wireless communication scheme to the second wireless communication scheme and which, if the wireless communication terminal having failed in the shift is detected, instructs the command transmitting section to transmit the shift command again.

A wireless communication method according to an aspect of the present invention includes:

transmitting a shift command for a shift from a first wireless communication scheme to a second wireless communication scheme to a wireless communication terminal, the first wireless communication scheme using a frequency bandwidth different from that used in the second wireless communication scheme;

after the transmission of the shift command, searching for a wireless communication terminal having failed to shift from the first wireless communication scheme to the second wireless communication scheme; and

if the wireless communication terminal having failed to shift to the second wireless communication scheme is detected, transmitting the shift command again.

### BRIEF DESCRIPTION OF THE SEVERAL VIEWS OF THE DRAWING

FIG. 1 is a block diagram of a wireless communication system according to a first embodiment of the present invention;

FIG. 2 is a band diagram showing a band used by wireless LAN terminals according to the first embodiment of the present invention;

FIG. 3 is a block diagram of a wireless LAN base station according to the first embodiment of the present invention;

FIG. 4 is a timing chart of a beacon frame and available communication schemes in the wireless communication system according to the first embodiment of the present invention;

FIG. 5 is a flowchart showing an operation performed by the wireless LAN base station according to the first embodiment of the present invention to control the communication scheme;

FIG. 6 is a flowchart of an operation performed by the wireless LAN base station according to the first embodiment of the present invention to detect a shift failing terminal;

FIG. 7 is a timing chart showing the status of the transmission and reception between the wireless LAN base station and the wireless LAN terminal in the wireless communication system according to the first embodiment of the present invention;

FIG. 8 is a timing chart showing the status of the transmission and reception between the wireless LAN base station and the wireless LAN terminal in the wireless communication system according to a variation of the first embodiment of the present invention;

FIG. 9 is a flowchart of an operation performed by a wireless LAN base station according to a second embodiment of the present invention to detect a shift failing terminal;

FIG. 10 is a timing chart showing the status of the transmission and reception between the wireless LAN base station and the wireless LAN terminal in the wireless communication system according to the second embodiment of the present invention;

FIG. 11 is a timing chart showing the status of the transmission and reception between the wireless LAN base station and the wireless LAN terminal in the wireless communication system according to a variation of the second embodiment of the present invention;

FIG. 12 is a flowchart of an operation performed by a wireless LAN base station according to a third embodiment of the present invention to detect a shift failing terminal;

FIG. 13 is a timing chart showing the status of the transmission and reception between the wireless LAN base station and the wireless LAN terminal in the wireless communication system according to the third embodiment of the present invention; and

FIG. 14 is a timing chart showing the status of the transmission and reception between the wireless LAN base station and the wireless LAN terminal in the wireless communication system according to a variation of the third embodiment of the present invention.

### DETAILED DESCRIPTION OF THE INVENTION

### First Embodiment

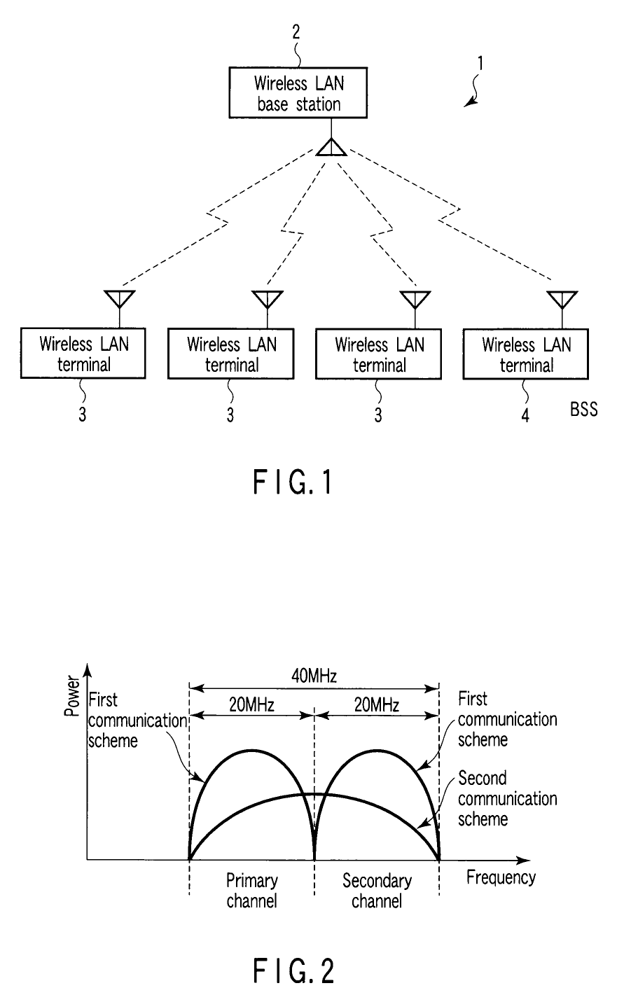

With reference to FIG. 1, description will be given of a wireless communication base station device according to a first embodiment of the present invention. FIG. 1 is a block diagram of a wireless communication system according to the present embodiment.

As shown in FIG. 1, a wireless communication system 1 includes a wireless LAN base station (hereinafter referred to as an access point) 2 and a plurality of wireless LAN terminals 3 and 4. The wireless LAN base station and the wireless LAN terminals form a communication network (LAN). Each of the wireless LAN terminals 3 wirelessly communicates with the access point 2 using a 20-MHz frequency band (this type of communication is hereinafter sometimes referred to as a first communication scheme) and a 40-MHz frequency band (this type of communication is hereinafter sometimes referred to as a second communication scheme). In contrast, the wireless LAN terminal 4 wirelessly communicates with the access point 2 using the 20-MHz frequency band (first communication scheme).

The access point 2 accommodates the wireless LAN terminals 3 to form a BSS (Basic Service Set). The access point 2 is connected to a server (not shown) by, for example, a wired LAN or to the Internet by a metal line or optical fibers via an Internet service provider. The access point 2 sets a communication period based on the first communication scheme (this is sometimes referred to as a first communication period) and a communication period based on the second communication scheme (this is sometimes referred to as a second communication period). During the first communication period, the wireless LAN terminals 3 and 4 can perform communication in accordance with the first communication scheme. On the other hand, during the second communication period, the wireless LAN terminals 3 can perform communication in accordance with the second communication scheme, whereas the wireless LAN terminal 4 is inhibited from communication.

The above-described configuration provides a network that allows the single access point 2 to simultaneously use the first communication scheme and the second communication scheme. FIG. 2 is a band diagram showing frequency bands used by the wireless LAN terminals 3 and 4 in accordance with the IEEE 802.11n standards.

The conventional LAN scheme uses the 20-MHz band as one channel to perform communication in the 20-MHz band (first communication scheme). The IEEE 802.11n standards additionally permit the 40-MHz band communication (second communication scheme) also using the adjacent 20-MHz band. However, with backward compatibility with existing wireless LAN terminals taken into account, both the 20-MHz band communication and the 40-MHz band communication are used. Here, a channel accommodating the wireless LAN terminals performing only the 20-MHz band communication is called a primary channel. A channel used to extend the band for the 40-MHz band communication is called a secondary channel. In an example in FIG. 2, the primary channel is located on a lower frequency side of the secondary channel. However, this may be reversed.

Wireless LAN terminals that can perform only the 20-MHz band communication cannot receive frames transmitted through the 40-MHz band, affecting interconnections. Thus, the IEEE 802.11n standards include schemes of allowing the coexistence of wireless LAN terminals capable only of the 20-MHz band communication and wireless LAN terminals capable of both the 20-MHz band communication and the 40-MHz band communication. One of those schemes is an optional function called a PCO function.

With the PCO function, the access point using the PCO function takes the initiative in setting a 20-MHz band communication period (first communication period) and a 40-MHz band communication period (second communication period). The access point uses a management frame to notify all the wireless LAN terminals accommodated by the wireless LAN base station, of a period shift to command the wireless LAN terminals to shift to the appropriate period. Thus, during the second communication period, the terminals performing communication only in accordance with the first communication scheme, in other words, the terminals not having the PCO function, are inhibited from communication. This makes it possible to prevent interconnections from being affected. In the example in FIG. 1, the wireless LAN terminals 3 have the PCO function, which enables communication in accordance with the two communication schemes, the first communication scheme and the second communication scheme. On the other hand, the wireless LAN terminal 4 does not have the PCO function and can perform communication only in accordance with the first communication scheme.

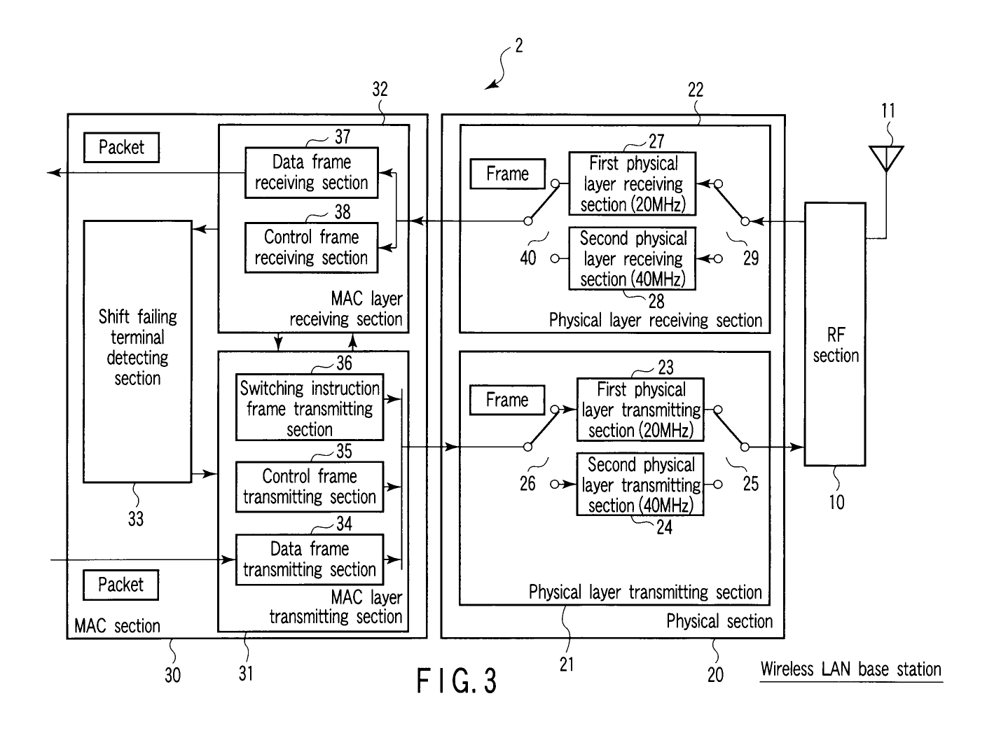

Now, with reference to FIG. 3, description will be given of the configuration of the access point 2, described with reference to FIG. 1. FIG. 3 is a block diagram showing the configuration of the access point 2.

As shown in FIG. 3, the access point 2 generally includes an RF (Radio Frequency) section 10, a physical section 20, and an MAC (Media Access Control) section 30. The RF section 10, for example, amplifies data in analog signals transmitted and received on the basis of wireless communication to transmit and receive data through an antenna 11. The physical section 20 and the MAC section 30 receive from an interface section (not shown), data downloaded from a server or the Internet and which is to be transmitted to the wireless LAN terminals 3, execute signal processing on the data, and then output the data to the RF section 10. The physical section 20 and the MAC section 30 execute signal processing on data received from the wireless LAN terminal 3 and output the resulting data to the interface section. The physical section 20 and the MAC section 30 will be described below in detail.

In the description below, data transmitted and received by the wireless LAN terminals 3 across the MAC section 30 is called a “frame”. Data transmitted and received by the interface across the MAC section 30 is called a “packet”. A packet is a data structure into which transmitted and received data is assembled and which can be handled by personal computers or the like. A frame is transmission or reception data assembled so as to be communicable on the basis of wireless communication.

First, with reference to FIG. 3, the configuration of the physical section 20 will be described. As shown in FIG. 3, the physical section 20 includes a physical layer transmitting section 21 and a physical layer receiving section 22.

The physical layer transmitting section 21 includes a first physical layer transmitting section 23, a second physical layer transmitting section 24, and switch elements 25 and 26. Under the control of the MAC section 30, the switch element 25 connects the first physical layer transmitting section 23 to the RF section 10 during the first communication period. The switch element 25 connects the second physical layer transmitting section 24 to the RF section 10 during the second communication period. Under the control of the MAC section 30, the switch element 26 connects the first physical layer transmitting section 23 to the MAC section 30 during the first communication period. The switch element 25 connects the second physical layer transmitting section 24 to the MAC section 30 during the second communication period.

The first and second physical layer transmitting sections 23 and 24 execute transmission processes for the first and second communication schemes, respectively, on a physical layer for transmit frames. Specifically, the first and second physical layer transmitting sections 23 and 24 subject a frame provided by the MAC section 30 via the switch element 25 to redundant coding during the first and second communication periods, respectively. Subsequently, the first and second physical layer transmitting sections 23 and 24 perform orthogonal frequency division multiplexing (OFDM) modulation to obtain a baseband transmit signal. The first and second physical layer transmitting sections 23 and 24 further perform D/A conversion on the baseband transmit signal to obtain an analog signal and output the signal to the RF section 10 via the switch element 25.

The physical layer receiving section 22 includes a first physical layer receiving section 27, a second physical layer receiving section 28, and switch elements 29 and 40. Under the control of the MAC section 30, the switch element 29 connects the first physical layer receiving section 27 to the RF section 10 during the first communication period. The switch element 29 connects the second physical layer receiving section 28 to the RF section 10 during the second communication period. Under the control of the MAC section 30, the switch element 40 connects the first physical layer receiving section 27 to the MAC section 30 during the first communication period. The switch element 40 connects the second physical layer receiving section 28 to the MAC section 30 during the second communication period.

The first and second physical layer receiving sections 27 and 28 execute transmission processes for the first and second communication schemes, respectively, on a physical layer for receive frames. Specifically, the first and second physical layer receiving sections 27 and 28 subject a frame provided by the RF section 10 via the switch element 29 to A/D conversion during the first and second communication periods, respectively. Subsequently, the first and second physical layer receiving sections 27 and 28 perform OFDM demodulation and corrective decoding to obtain a frame. The first and second physical layer receiving sections 27 and 28 then output the resulting frame to the MAC section 30 via the switch element 40.

During the second communication period, the 40-MHz frequency band contains the 20-Mhz band of the primary channel. The physical section 20 configured as described can thus receive not only frames transmitted in accordance with the second communication scheme but also frames transmitted in accordance with the first communication scheme.

However, if the physical section 20 receives a frame in accordance with the first communication scheme while waiting for a frame in accordance with the second communication scheme, reception performance generally tends to be degraded owing to the adverse effect of noise in the secondary channel. In addition, more power is required while the physical section 20 is waiting for a frame in accordance with the second communication scheme. Consequently, the physical section 20 usually waits for a frame in accordance with the first communication scheme and in accordance with the second communication scheme only when required. While waiting for a frame in accordance with the first communication scheme, the physical section 20 cannot receive any frame transmitted in accordance with the second communication scheme.

Now, with reference to FIG. 3, the configuration of the MAC section 30 will be described. The MAC section 30 includes an MAC layer transmitting section 31, an MAC layer transmitting section 32, and a shift failing terminal detecting section 33.

First, the MAC layer transmitting section 31 will be described. The MAC layer transmitting section 31 includes a data frame transmitting section 34, a control frame transmitting section 35, and a switching instruction frame transmitting section 36. The data frame transmitting section 34 adds an MAC header to a packet delivered from an upper layer of a MAC layer to assemble a frame and outputs the frame to the physical layer transmitting section 21. That is, the data frame transmitting section 34 has a function of transmitting a data frame MPDU (MAC Protocol Data Unit) as single data or transmitting A-MPDU (Aggregated-MPDU) obtained by aggregating a plurality of MPDUs together.

The control frame transmitting section 35 has a function of transmitting control frames. That is, the control frame transmitting section 35 creates a response frame for the data frame MPDU (this response frame is hereinafter referred to as an ACK (Acknowledge) frame), a response frame for the data frame A-MPDU or a BAR (Block ACK Request) frame (this response frame is hereinafter referred to as a BA (Block ACK) frame), or the like to transmit the response frame.

When a frame is transmitted and received between the access point 2 and any of the wireless LAN terminals 3 and 4, the response frame (ACK frame and BA frame) notifies the transmitter of whether or not the receiver has been able to accurately receive the frame. For example, if the access point 2 has transmitted a frame, one of the wireless LAN terminals 3 and 4 specified as the destination transmits the response frame to the access point 2. This allows the access point 2 to determine whether or not the frame has been correctly transmitted. If the frame has not been correctly transmitted, the access point 2 retransmits the frame.

The BA frame, which is one of the response frames, is used for Block acknowledgement scheme. In the Block acknowledgement scheme, one BA frame is used to acknowledge that data containing a plurality of data frames and managed on the basis of the same traffic ID has been successfully transmitted. Furthermore, the BAR frame is used by the frame transmitter to request a BA frame from the receiver.

The switching instruction frame transmitting section 36 generates a frame instructing the wireless LAN terminal 3 to switch from the first communication scheme to the second communication scheme and transmits the frame. The frame is, for example, a beacon frame or a Set PCO Phase frame.

Now, the MAC layer receiving section 32 will be described. The MAC layer receiving section 32 includes a data frame receiving section 37 and a control frame receiving section 38. Upon receiving the data frame MPDU or A-MPDU, the data frame receiving section 37 removes a MAC header from the frame to assemble a packet and passes the packet to the upper layer. The control frame receiving section 38 receives the control frame such as the ACK frame or the BA frame.

Now, the shift failing terminal detecting section 33 will be described. The shift failing terminal detecting section 33 detects the wireless LAN terminal 3 having failed to shift from the first communication scheme to the second communication scheme. If any such wireless LAN terminal is detected, the shift failing terminal detecting section 33 commands the switching instruction frame transmitting section 36 to transmit a frame instructing the terminal to perform the switching. The wireless LAN terminal 3 having failed in the shift is detected by monitoring a frame received by the MAC layer receiving section 32 or a frame transmitted by the MAC layer transmitting section 31, during the second communication period. The detection method will be described below in detail.

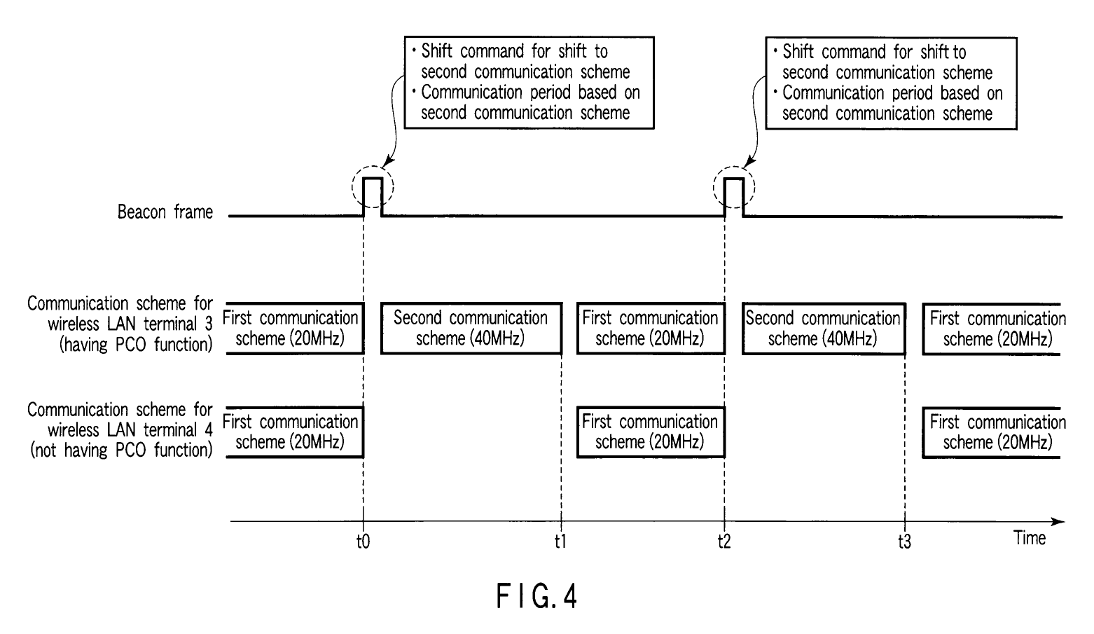

The control of the communication scheme performed by the access point 2 will be described in brief first with reference to FIG. 4. FIG. 4 is a timing chart showing a beacon frame transmitted by the access point 2 and changes in the communication scheme used by the wireless LAN terminals 3 and 4. As shown in FIG. 4, the access point 2 sets the first communication period for a period until a time t0. This allows all the wireless LAN terminals 3 and 4 to communicate in accordance with the first communication scheme.

At the time t0, the access point 2 transmits the beacon frame to the wireless LAN terminals 3 and 4. The beacon frame includes a shift command for a shift from the first communication scheme to the second communication scheme, and a timing for returning to the first communication scheme after the shift, that is, information on the length of the second communication period. The wireless LAN terminals 3, having the PCO function, shift to the second communication scheme through a specified transition period. The wireless LAN terminal 4, not having the PCO function, is inhibited from communication during the second communication period. When the second communication period ends at a time t1, the access point 2 sets the first communication period again. The wireless LAN terminals 3 then shifts to the first communication scheme through a specified transition period. The wireless LAN terminal 4 is also allowed to communicate. Subsequently, for communication in accordance with the second communication scheme, the access point 2 sets the second communication period using the beacon frame.

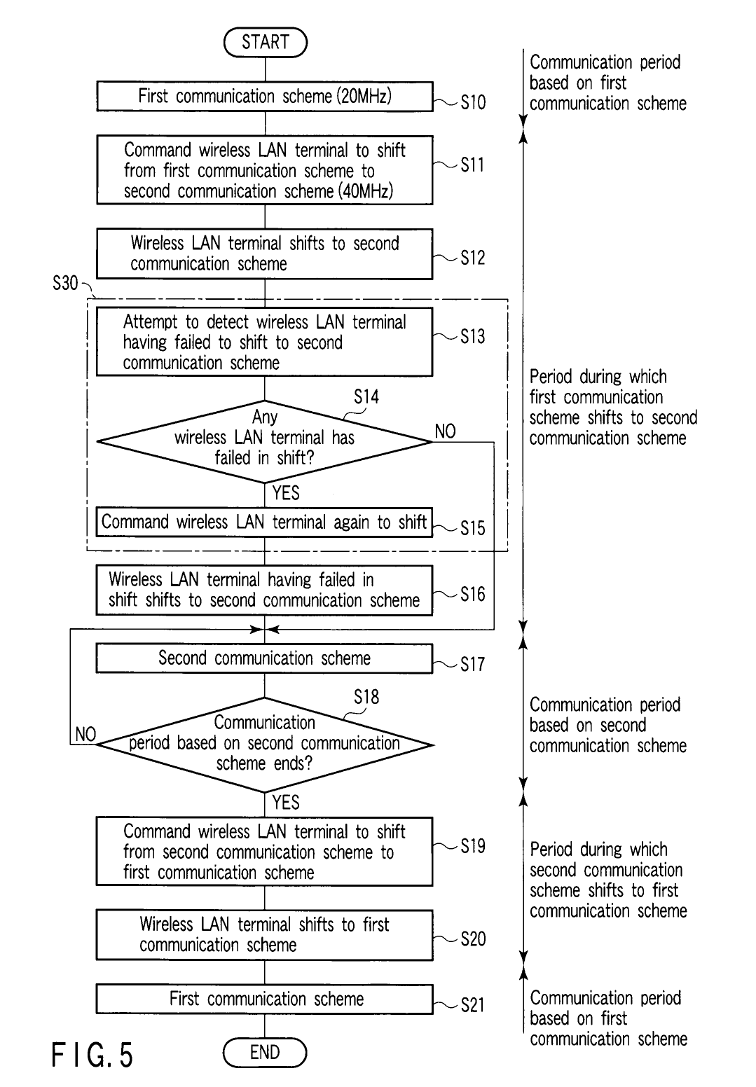

With reference to FIG. 5, a detailed description will be given of a method by which the access point 2 allows the communication scheme to be shifted. FIG. 5 is a flowchart showing the flow of a process executed by the access point 2.

As shown in FIG. 5, the access point 2 sets the first communication period, and the wireless LAN terminals 3 and 4 transmit and receive frames in accordance with the first communication scheme (20-MHz band) (step S10). During this period, in the access point 2, the switch elements 25 and 26 connect the RF section 10 and the MAC section 30, respectively, to the first physical layer transmitting section 23. The switch elements 29 and 40 connect the RF section 10 and the MAC section 30, respectively, to the first physical layer receiving section 27. Consequently, frames transmitted and received in accordance with the first communication scheme are subjected to a transmitting process and a receiving process by the first physical layer transmitting section 23 and the first physical layer receiving section 27, respectively.

Then, the access point 2 commands the wireless LAN terminals 3 to shift from the first communication scheme to the second communication scheme (40-MHz band) (step S11). That is, the switching instruction frame transmitting section 36 in the MAC layer transmitting section 31 generates the beacon frame or Set PCO Phase frame with destinations specified as broadcast addresses. The beacon frame or Set PCO Phase frame is transmitted to all the wireless LAN terminals 3 and 4 accommodated by the access point 2 to instruct the terminals 3 and 4 to shift to the second communication scheme.

In this case, the switching instruction frame transmitting section 36 sets the duration from the shift to the second communication scheme until the return to the first communication scheme, in a duration field of the beacon frame or the Set PCO Phase frame. This sets a communication standby period called NAV (Network Allocation Vector) for all the wireless LAN terminals 3 and 4, which are thus set to a communication standby status.

Subsequently, the access point 2 and the wireless LAN terminals 3, using the PCO function, uses the transition period, preset by the access point 2, to shift to the second communication scheme (40-MHz band communication) (step S12).

In addition, the access point 2 sets NAV for the secondary channel during the transition period. That is, to set other wireless LAN terminals present on the secondary channel but which are not accommodated by the wireless LAN base station 2, to the communication standby status, the control frame transmitting section 35 transmits a CTS-self frame on the secondary channel. The duration until the return to the first communication scheme is set in the Duration field of the CTS-self frame. The CTS-self frame may be transmitted on both the primary channel and the secondary channel. However, since the purpose of the frame is as described above, it is sufficient to transmit the frame only on the secondary channel.

When the transition period ends, the control frame transmitting section 35 of the access point 2 transmits a CF-End frame in accordance with the second communication scheme. The CF-End frame enables the communication standby status set by NAV to be cleared. Since the CF-End frame is transmitted in accordance with the second communication scheme, only the wireless LAN terminal 3 using the PCO function and having shifted to the second communication scheme can correctly receive the CF-End frame. Thus, the wireless LAN terminal 3 having shifted to the second communication scheme can start communication.

Then, in the access point 2, the shift failing terminal detecting section 33 detects the wireless LAN terminal 3 having failed to shift from the first communication scheme to the second communication scheme (step S13). That is, the access point 2 searches for any of the wireless LAN terminals 3 accommodated by the access point 2 and having the PCO function which terminal is still operating in accordance with the first communication scheme.

In step S13, upon finding the wireless LAN terminal 3 having failed in the shift (step S14, YES), the shift failing terminal detecting section 33 commands the switching instruction frame transmitting section 36 to retransmit the switching instruction frame (step S15). In accordance with this command, the switching instruction frame transmitting section 36 transmits a frame instructing the terminal to shift from the first communication scheme to the second communication scheme, as a broadcast frame. The broadcast frame is transmitted to destinations specified as broadcast addresses, that is, to all the wireless LAN terminals accommodated by the access point.

In step S15, the wireless LAN terminal 3 having failed to shift to the second communication scheme in step S11 shifts to the second communication scheme (step S16). Then, until the second communication scheme ends (step S18, NO), the access point 2 communicates with the wireless LAN terminals 3, having the PCO function, in accordance with the second communication scheme (step S17). During this period, in the access point 2, the switch elements 25 and 26 connect the RF section 10 and the MAC section 30, respectively, to the second physical layer transmitting section 24. The switch elements 29 and 40 connect the RF section 10 and the MAC section 30, respectively, to the second physical layer receiving section 28. Consequently, frames transmitted and received in accordance with the second communication scheme are subjected to a transmitting process and a receiving process by the second physical layer transmitting section 24 and the second physical layer receiving section 28, respectively.

When the second communication period ends (step S18, YES), the access point 2 commands the wireless LAN terminals 3 to return from the second communication scheme to the first communication scheme (step S19). That is, the switching instruction frame transmitting section 36 in the access point 2 transmits the Set PCO Phase frame as a broadcast frame in accordance with the second communication scheme. The wireless LAN terminals 3 thus shift from the second communication scheme to the first communication scheme (step S20).

In this case, the access point 2 sets a transition period as is the case with the shift to the second communication scheme. During the transition period, the access point 2 transmits the CF-End frame to the secondary channel. Thus, when the first communication scheme is shifted to the second communication scheme, NAV set in the CTS-self frame is cleared to end the communication standby status.

Furthermore, when the transition period ends, the access point 2 transmits the CF-End frame through the primary channel. This clears NAV for the wireless LAN terminal 4, accommodated by the access point 2 and not using the PCO function, to end the communication standby status of the wireless LAN terminal 4.

As a result, all the wireless LAN terminals 3 and 4 accommodated by the access point 2 can restart communication in accordance with the first communication scheme (step S21).

The series of frame exchanges described above allow the access point 2 to optionally set the first communication scheme and the second communication scheme. This enables the coexistence of both the wireless LAN terminals 3, which can communicate in accordance with the second communication scheme owing to the PCO function, and the existing wireless LAN terminal 4 and the wireless LAN terminal 4 which conforms to the IEEE 802.11n standards but which can use only the first communication scheme.

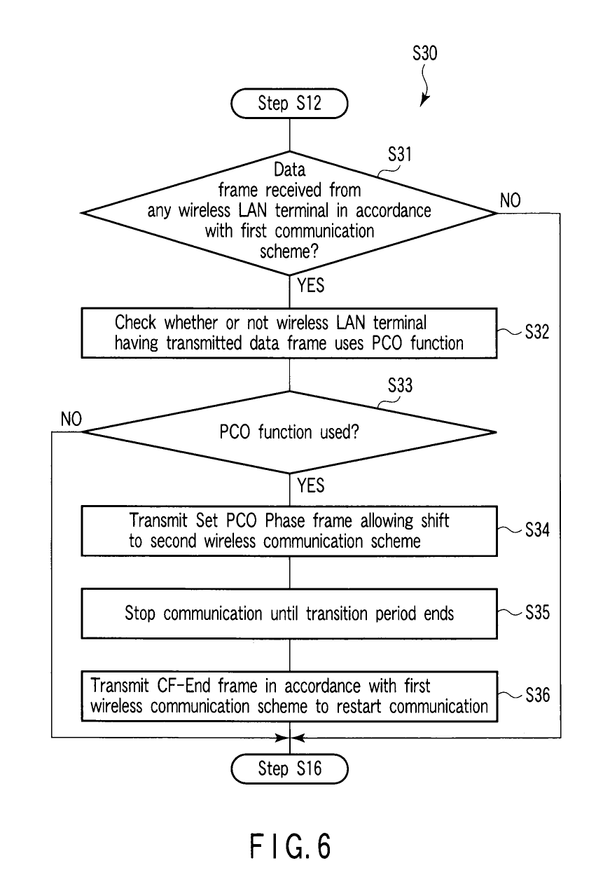

Now, steps S13 to S15, described above, are considered to be step S30, and step S30 will be described in detail with reference to FIG. 6. FIG. 6 is a flowchart showing the details of step S30.

As shown in FIG. 6, after the wireless LAN terminals 3 shift to the second communication scheme in step S12, the shift failing terminal detecting section 33 monitors whether or not the data frame receiving section 37 has received a data frame from any of the wireless LAN terminals in accordance with the first communication scheme (step S31).

If the data frame receiving section 37 has received a data frame from any of the wireless LAN terminals 3 and 4 in accordance with the first communication scheme (step S31, YES), the shift failing terminal detecting section 33 checks whether or not the wireless LAN terminal 3 or 4 uses the PCO function (step S32). Which of the wireless LAN terminals uses the PCO function is known to the access point 2. This is because, upon connecting to the access point 2, the wireless LAN terminal using the PCO function clearly indicates the use of the PCO function to the access point 2.

If in step S32, the wireless LAN terminal having transmitted data in accordance with the first communication scheme is determined to use the PCO function (step S33, YES), the shift failing terminal detecting section 33 determines that this wireless LAN terminal 3 has failed to shift to the second communication scheme. If the wireless LAN terminal having transmitted data in accordance with the first communication scheme is determined not to use the PCO function (step S33, NO), the process proceeds to step S16 to start communication in accordance with the second communication scheme.

If any of the wireless LAN terminals 3 have failed in the shift (step S33, YES), the shift failing terminal detecting section 33 commands the switching instruction frame transmitting section 36 to transmit the Set PCO Phase frame. In accordance with the command, the switching instruction frame transmitting section 36 generates and transmits the Set PCO Phase frame to command the wireless LAN terminals 3 and 4 to shift to the second communication scheme (step S34).

The Set PCO Phase frame is normally broadcast to all the wireless LAN terminals and thus transmitted as a broadcast frame. However, in step S34, it is sufficient that only the wireless LAN terminal determined to have failed to shift to the second communication scheme can receive the Set PCO Phase frame. Thus, the switching instruction frame transmitting section 36 may transmit the Set PCO Phase frame in this case as a unicast frame destined for the wireless LAN terminal determined to have failed in the shift.

If the Set PCO phase frame is transmitted as a unicast frame, it is possible to receive an acknowledge response in the ACK frame from the wireless LAN terminal 3, which responds to the Set PCO frame. This makes it possible to reliably instruct the wireless LAN terminal to shift to the second communication scheme.

After transmitting the Set PCO Phase frame in step S34, the access point 2 sets a transition period as is the case with the normal shift to the second communication scheme. The control frame transmitting section 35 then transmits the CTS-self frame to inhibit all the wireless LAN terminals 3 and 4 from communication (step S35). When the transition period ends, the CF-End frame is transmitted in accordance with the second communication scheme to clear NAV only for the wireless LAN terminal 3 having shifted to the second communication scheme. The wireless LAN terminal then starts data transmission and reception in accordance with the second communication scheme together with the wireless LAN terminal having failed in the shift in step S11 (step S36).

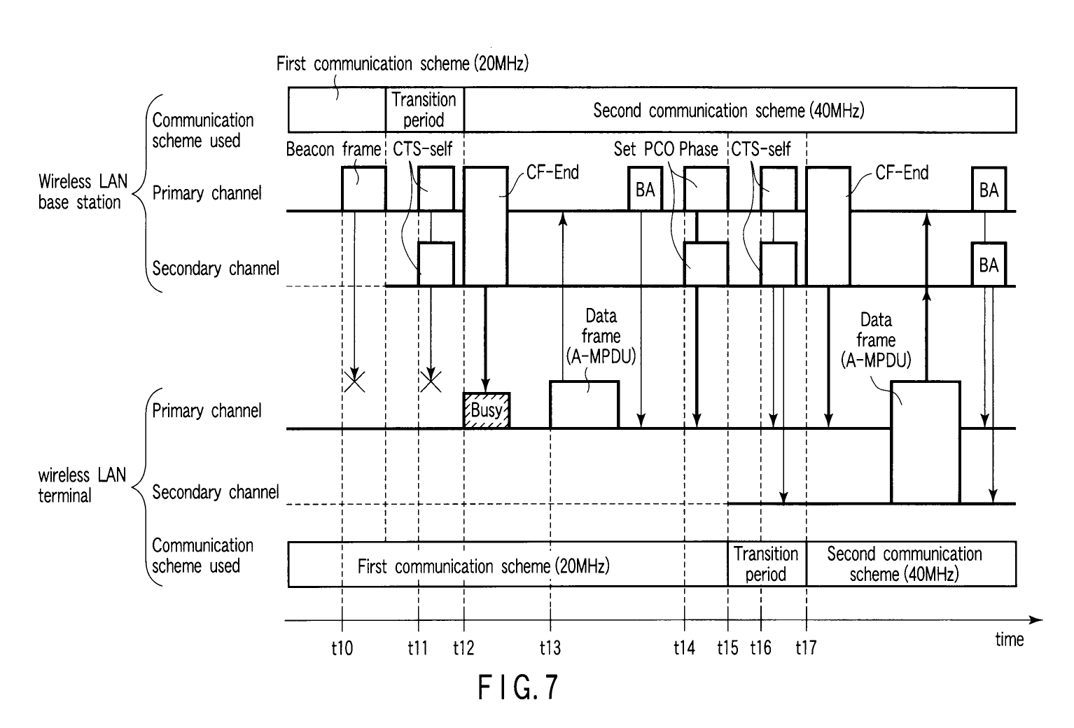

Now, with reference to FIG. 7, description will be given of a specific example of the operation described with reference to FIGS. 5 and 6, focusing on the shift from the first communication scheme to the second communication scheme. FIG. 7 is a time chart showing how frames are transmitted and received between the access point 2 and the wireless LAN terminal 3.

As shown in FIG. 7, at a time t10 during the first communication period, the access point 2 transmits the beacon frame on the primary channel in accordance with the first communication scheme in order to instruct the terminal to shift to the second communication scheme. At this time, information on the shift to the second communication scheme is contained in the beacon frame for transmission. Upon receiving the beacon frame, the wireless LAN terminal 3 using the PCO function normally shifts to the second communication scheme. However, it is assumed that the wireless LAN terminal 3 shown in FIG. 7 has failed to receive the beacon frame and has not performed an operation of shifting to the second communication scheme. In FIG. 7, crosses indicate that the wireless LAN terminal has failed to receive the transmitted frame.

Moreover, at a subsequent time t11 during the transition time, the access point 2 simultaneously transmits the CTS-self frame on both the primary channel and the secondary channel in accordance with the first communication scheme. If the wireless LAN terminal 3 has also failed to receive the CTS-self frame, even NAV is not set for the wireless LAN terminal 3.

Then, at a time t12, the access point 2 transmits the CF-End frame in accordance with the second communication scheme. As a result, NAV is cleared only for the wireless LAN terminal 3 having successfully shifted to the second communication scheme. This wireless LAN terminal 3 thus starts data transmission and reception in accordance with the second communication scheme. However, the wireless LAN terminal 3 having failed in the shift is still operating in accordance with the first communication scheme and does not even have the NAV setting as shown in FIG. 7. Consequently, as shown at a time t13, this wireless LAN terminal 3 transmits data in the A-MPDU frame in accordance with the first communication scheme during the second communication period.

Upon receiving the A-MPDU frame, the access point 2 checks whether or not the wireless LAN terminal 3 uses the PCO function. In the present example, the wireless LAN terminal 3 uses the PCO function. The access point 2 thus determines that the wireless LAN terminal 3 has failed to shift to the second communication scheme.

Thus, in response to the received A-MPDU frame, the access point 2 thus returns the BA frame to the wireless LAN terminal 3 in accordance with a normal data frame transmission and reception sequence. Subsequently, at a time t14, the access point 2 simultaneously transmits the Set PCO Phase frame on both the primary channel and the secondary channel in accordance with the first communication scheme to instruct the terminal to shift to the second communication scheme.

In the example in FIG. 7, the access point 2 transmits the BA frame in response to the A-MPDU frame. However, the access point 2 does not necessarily transmit the BA frame. This is because the wireless LAN terminal using the PCO function is normally inhibited from transmitting data frames in accordance with the first communication scheme during the second communication period. Furthermore, in FIG. 7, the Set PCO Phase frame is simultaneously transmitted on both the primary channel and the secondary channel. However, the Set PCO Phase frame may be transmitted only on the primary channel in accordance with the first communication scheme.

Subsequently, upon receiving the rescue Set PCO Phase frame transmitted at the time t14, the wireless LAN terminal 3 enters the transition period (at a time t15) after reception. During the transition period, the wireless LAN terminal 3 shifts to the second communication scheme.

At a time t16 during the transition period, the access point 2 transmits the CTS-self frame to set NAV as in the case of the normal transition period. The NAV setting is not necessarily required. This is because in this condition, the NAV setting is finished during the normal transition period.

Subsequently, at a time t17 when the transition period for the wireless LAN terminal 3 ends, the access point 2 transmits the CF-End frame to the wireless LAN terminal 3 to allow the wireless LAN terminal 3 to restart communication in accordance with the second communication scheme.

As described above, the wireless communication system in accordance with the first embodiment of the present invention exerts an effect (1).

(1) Data Transmission Efficiency can be Improved (1).

As previously described, the IEEE 802.11n standards, which are now being established, adopt the PCO function as an optional function. This enables the coexistence of the communication scheme utilizing the 20-MHz band and the communication scheme utilizing the 40-MHz band in a single BSS.

However, the transmission frame used to shift the communication scheme is a broadcast frame that does not require a response frame acknowledging that the transmission frame has been delivered. This makes it impossible to check whether or not all the wireless LAN terminals in a BSS have correctly received the frame. If the wireless LAN terminal using the PCO function has failed to receive the frame, the wireless LAN terminal cannot shift to the 40-MHz band communication and remains in the 20-MHz band communication status. Thus, the wireless LAN terminal cannot transmit or receive data during the 40-MHz band communication period.

Moreover, the access point does not recognize the presence of the wireless LAN terminal having failed in the shift. Thus, the access point interprets that the access point can transmit and receive data to and from the wireless LAN terminal having failed in the shift, using the 40-MHz band. The access point is thus likely to transmit a data frame to the wireless LAN terminal using the 40-MHz band. However, in this case, the wireless LAN terminal cannot correctly receive the data frame. Thus, the access point repeats retransmitting the data frame, reducing the efficiency with which the entire band is used.

However, after the access point 2 according to the present embodiment transmits the beacon frame, functioning as a frame instructing the terminal to shift the communication scheme, the shift failing terminal detecting section 33 detects the wireless LAN terminal 3 having failed in the shift. If any wireless LAN terminal 3 has failed in the shift, the shift failing terminal detecting section 33 commands the switching instruction frame transmitting section 36 to transmit the shift instruction frame (Set PCO Phase frame).

More specifically, after the transmission of the beacon frame, the shift failing terminal detecting section 33 monitors whether or not the data frame receiving section 32 has received the frame transmitted in accordance with the first communication scheme. If the data frame receiving section 32 has received the frame and the wireless LAN terminal 3 having transmitted the frame is determined to use the PCO function, the shift failing terminal detecting section 33 determines that the wireless LAN terminal 3 has failed in the shift. This is because the PCO standards inhibit data frames from being transmitted in accordance with the first communication scheme during the second communication period.

As described above, the retransmission of the shift command makes it possible to rescue the wireless LAN terminal 3 having failed in the shift in response to the first shift command. That is, the wireless LAN terminal can be shifted to the second communication scheme. As a result, the wireless LAN terminal 3, having the PCO function, can be prevented from being disabled to communicate during the second communication period. This also makes it possible to prevent frames from being transmitted in accordance with the first communication scheme during the second communication period. It is therefore possible to prevent the frequency bands from being inefficiently occupied and to improve the efficiency with which the whole BSS, managed by the wireless LAN base station 2, utilizes the frequency bands.

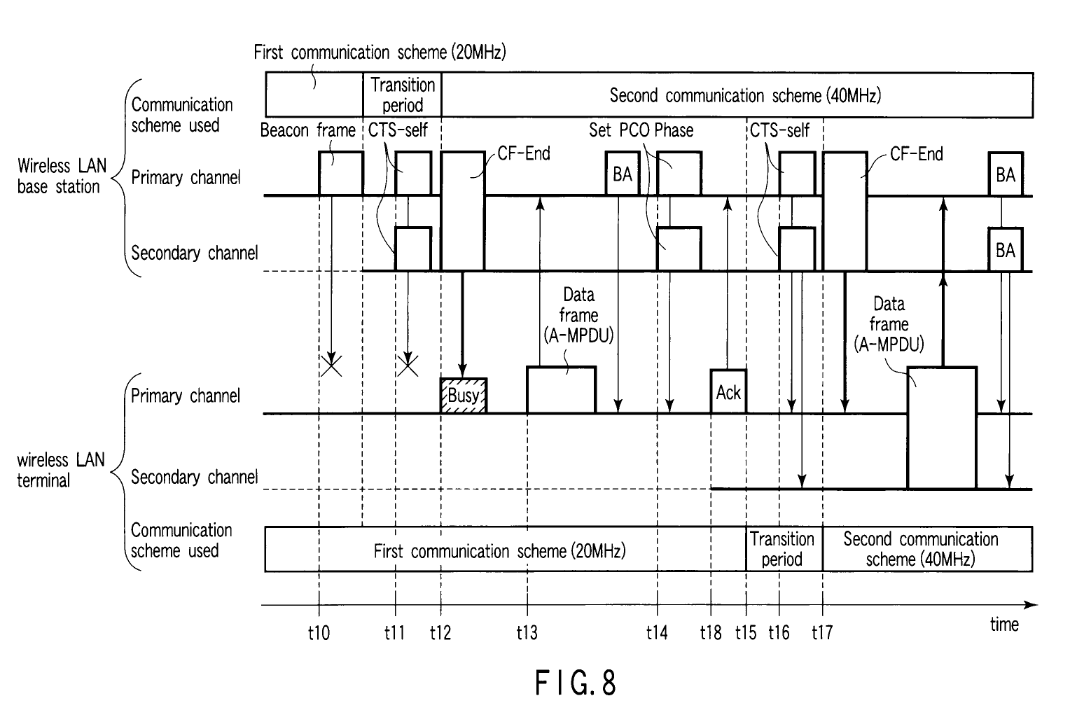

As described above, the access point 2 may transmit the Set PCO Phase frame as a unicast frame. FIG. 8 is a time chart showing how frames are transmitted and received between the access point 2 and the wireless LAN terminal 3 when the access point 2 transmits the Set PCO Phase frame as a unicast frame.

In the above-described embodiment, the Set PCO Phase frame is transmitted as a broadcast frame, as is the case with the normal PCO sequence. Thus, in this case, no response frame is obtained. However, as shown in FIG. 8, by transmitting a unicast frame with a destination specified as the wireless LAN terminal 3 determined to have failed in the shift, it is possible to obtain the ACK frame, that is, the acknowledge frame, from the wireless LAN terminal 3 (at a time t18).

The present method makes it possible to eliminate the possibility that even the Set PCO Phase frame transmitted for rescue does not reach the wireless LAN terminal 3 having failed in the shift. This is because when the Set PCO Phase frame is transmitted as a unicast frame transmitted in expectation of a response frame, if the wireless LAN terminal fails to receive the Set PCO Phase frame and does not transmit the response frame, the access point 2 can determine that the Set PCO Phase frame has failed to be transmitted. In this case, the access point 2 can transmit the Set PCO Phase frame again.

### Second Embodiment

Now, description will be given of a wireless communication base station device according to a second embodiment of the present embodiment. The present embodiment corresponds to the first embodiment in which the wireless LAN terminal having failed in the shift is detected by a method different from that shown in FIG. 6. Thus, the configuration and general operation of the access point 2 are similar to those in the first embodiment and will thus not be described. Only differences from the first embodiment will be described below.

The method according to the present embodiment first transmits a control frame in accordance with the first communication scheme. Then, a data frame is transmitted in accordance with the second communication scheme in expectation of a response frame. Then, the response frame for the control frame is received, and if the response frame for the control frame cannot be received, the wireless LAN terminal is determined to have failed in the shift.

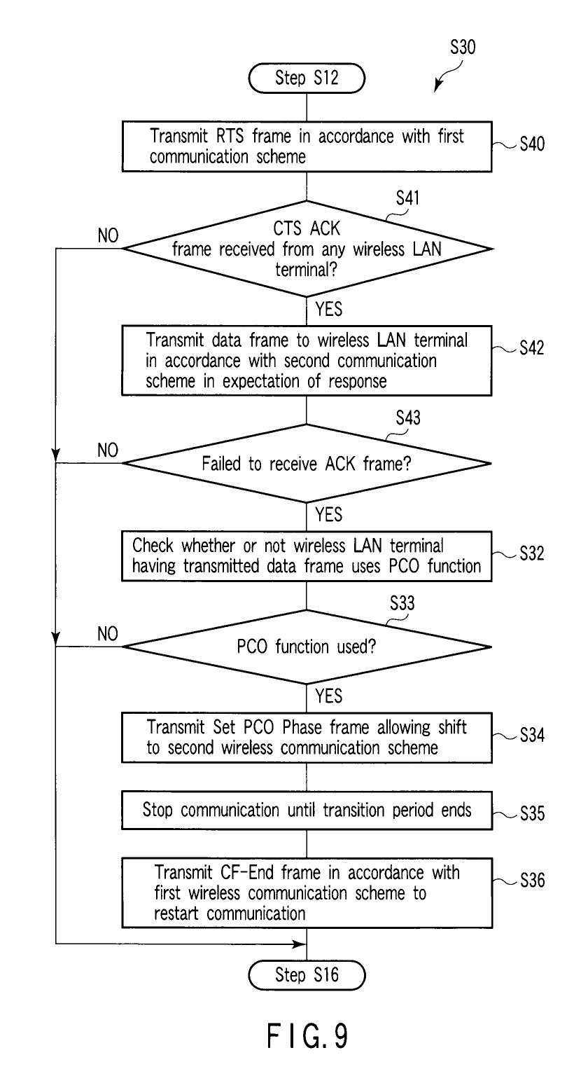

FIG. 9 is a flowchart showing the details of step S30 in FIG. 5. As shown in FIG. 9, after steps S10 to S12, described in the first embodiment, the control frame transmitting section 35 of the access point 2 transmits an RTS (Request To Send) frame to the wireless LAN terminals 3 and 4 in accordance with the first communication scheme (step S40).

The RTS frame is used to reserve a communication band and is a kind of control frame. Upon receiving the RTS frame, the wireless LAN terminals 3 and 4 respond to the access point 2 with a CTS frame. After the response, data frames can be consecutively transmitted. The RTS frame is also used in existing IEEE 802.11n-incompatible terminals. According to the IEEE 802.11n standards, the RTS frame is frequently used particularly for a function called a Long NAV scheme. The Long NAV scheme is as follows. The period that can be reserved by the RTS frame is normally limited to the period during which data frames or the like are to be consecutively transmitted. In contrast, the Long NAV scheme allows the reservation of frequency bands for a TXOP Limit (Transmission Opportunity Limit) period corresponding to the maximum period during which new consecutive transmissions can be performed.

The control frame such as the RTS frame is normally transmitted in accordance with the first communication scheme even during the second communication period. Thus, the access point or the like using the Long NAV scheme or the like to reserve frequency bands for the TXOP period for consecutive transmissions transmits the RTS frame during a normal data transmission sequence. The shift failing terminal detecting section 33 monitors this operation.

After the transmission of the RTS frame, if the control frame receiving section 38 has not received the CTS response frame from any of the wireless LAN terminals 3 and 4 (step S41, NO), the shift failing terminal detecting section 33 determines that no terminal has failed in the shift. The process thus proceeds to step S16. If the control frame receiving section 38 has received the CTS response frame (step S41, YES), the shift failing terminal detecting section 33 monitors whether or not the data frame transmitting section 34 has transmitted a data frame in accordance with the second communication scheme in expectation of a response frame. When the data frame is transmitted (step S42), the shift failing terminal detecting section 33 monitors whether or not the wireless LAN terminal 3 has transmitted the response frame for the data frame, that is, whether or not the control frame receiving section 38 has received the response frame.

If the control frame receiving section 38 has received the response frame (step S43, NO), the process proceeds to step S16. If the control frame receiving section 38 has not received the response frame (step S43, YES), the wireless LAN terminal has responded to the frame transmitted in accordance with the first communication scheme but not to the frame transmitted in accordance with the second communication scheme. At this time, the wireless LAN terminal is determined to operate in accordance with the first communication scheme.

Thus, the shift failing terminal detecting section 33 determines whether or not the wireless LAN terminal 3 or 4 uses the PCO function (step S32). Then, step S33 and the subsequent steps described in the first embodiment with reference to FIG. 6 are executed.

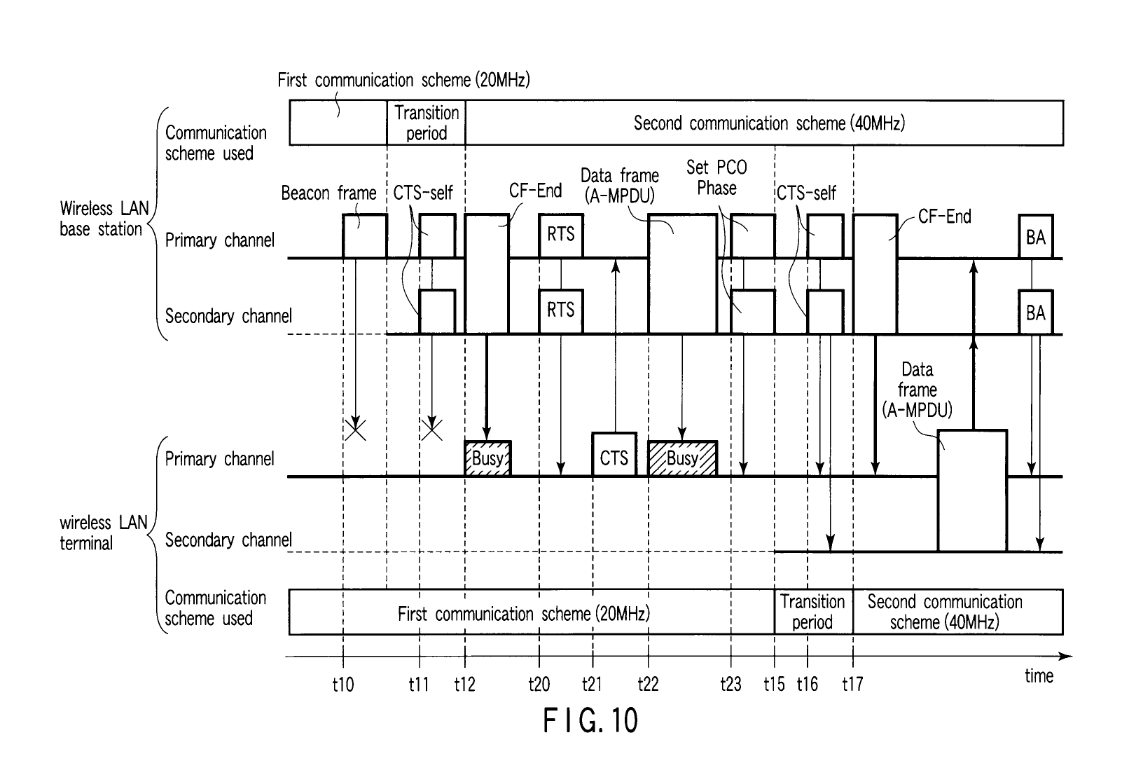

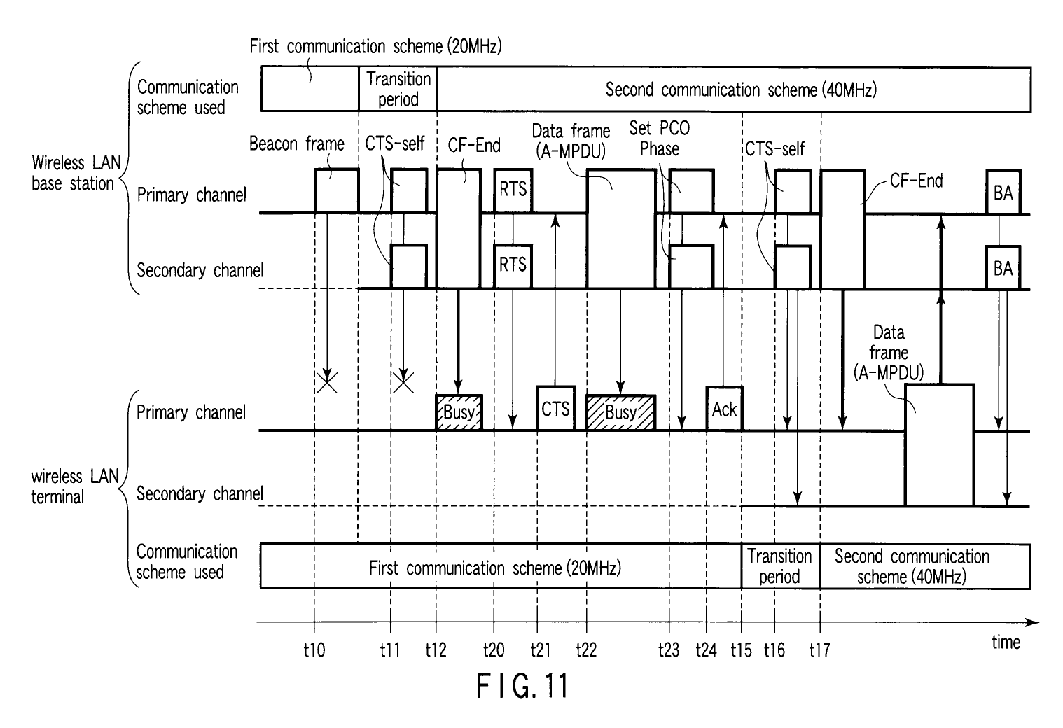

Now, with reference to FIG. 10, description will be given of a specific example of the operation described with reference to FIG. 9, focusing on the shift from the first communication scheme to the second communication scheme. FIG. 10 is a time chart showing how frames are transmitted and received between the access point 2 and the wireless LAN terminal 3.

As shown in FIG. 10, the operation performed until the time t12, when the access point 2 transmits the CF-End frame, is similar to that shown in FIG. 7, described in the first embodiment. Since the CF-End frame is transmitted in accordance with the second communication scheme, NAV is cleared only for the wireless LAN terminal 3 having successfully shifted to the second communication scheme. Data transmission and reception is started in accordance with the second communication scheme. However, the wireless LAN terminal 3 having failed in the shift is still operating in accordance with the first communication scheme and cannot transmit or receive data in accordance with the second communication scheme.

Then, in the access point 2, the control frame transmitting section 35 transmits the RTS frame to the wireless LAN terminals on both the primary channel and the secondary channel in accordance with the first communication scheme (at a time t20). The RTS frame may be transmitted only on the primary channel.

The RTS frame transmitted in accordance with the first communication scheme can also be received by the wireless LAN terminal 3 having failed in the shift and is still operating in accordance with the first communication scheme. Consequently, at a time t21, the wireless LAN terminal 3 returns the CTS response frame to the access point 2 on the primary channel in accordance with the first communication scheme. The shift failing terminal detecting section 33 determines that the control frame receiving section 38 has received the CTS frame.

Subsequently, during the second communication period, the access point 2 transmits the A-MPDU frame, obtained by aggregating a plurality of data frames together, to the wireless LAN terminal 3 having failed in the shift, in accordance with the second communication scheme (at a time t22). However, since the wireless LAN terminal 3 communicates in accordance with the first communication scheme, the wireless LAN terminal 3 cannot receive this frame and can thus only recognize a band busy status in which noise is present on the transmission path.

The A-MPDU frame transmitted at the time 22 is transmitted in expectation of a response with the BA frame. However, the wireless LAN terminal 3, the destination of the A-MPDU frame, cannot receive the frame, and does not return the BA frame.

Upon recognizing that the BA frame has not been successfully received, the shift failing terminal detecting section 33 determines that the wireless LAN terminal 3 is communicating in accordance with the first communication scheme. The shift failing terminal detecting section 33 thus checks whether or not the wireless LAN terminal 3 uses the PCO function. Upon determining that the wireless LAN terminal 3 uses the PCO function, the shift failing terminal detecting section 33 further determines that the wireless LAN terminal 3 has failed in the shift.

The shift failing terminal detecting section 33 thus commands the switching instruction frame transmitting section 36 to transmit the Set PCO Phase frame again. Thus, at a time t23, the access point 2 simultaneously transmits the Set PCO Phase frame on both the primary channel and the secondary channel to command the terminal again to shift to the second communication scheme.

The operation performed after the time t15 is similar to that in the first embodiment.

As described above, the wireless communication system according to the second embodiment of the present invention exerts an effect (2).

(2) The Data Transmission Efficiency can be Improved (2).

The wireless communication system according to the present embodiment uses a method described below to detect the wireless LAN terminal having failed to shift from the first communication scheme to the second communication scheme.

The shift failing terminal detecting section 33 monitors whether or not the CTS frame has been received in response to the RTS frame transmitted in accordance with the first communication scheme. Moreover, when a data frame is transmitted to the wireless LAN terminal 3 having transmitted the CTS frame, in accordance with the second communication scheme in expectation of a response, the shift failing terminal detecting section 33 monitors whether or not the response frame for the data frame has been received. If the wireless LAN terminal, having transmitted the CTS frame but not the response frame for the data frame, uses the PCO function, the shift failing terminal detecting section 33 determines that the wireless LAN terminal has failed in the shift. This is because the wireless LAN terminal can receive the data frame transmitted in accordance with the first communication scheme but not the data frame transmitted in accordance with the second communication scheme, meaning that the wireless LAN terminal is still communicating in accordance with the first communication scheme.

The shift command is then transmitted again to the wireless LAN terminal 3 having failed in the shift to rescue the wireless LAN terminal 3. This makes it possible to exert an effect similar to the effect (1), described in the first embodiment. Furthermore, the transmission of the RTS frame is commonly performed in order to set the communication period as described above. This eliminates the need to, for example, transmit a new frame only to detect a shift failing terminal, allowing the shift failing terminal to be easily detected.

Of course, also in the present embodiment, the access point 2 may transmit the Set PCO Phase frame as a unicast frame. FIG. 11 is a time chart showing how frames are transmitted and received between the access point 2 and the wireless LAN terminal 3 when the access point 2 transmits the Set PCO Phase frame as a unicast frame. As shown in FIG. 11, by transmitting the Set PCO Phase frame as a unicast frame at the time t23, it is possible to obtain the ACK frame at a time t24.

### Third Embodiment

Now, description will be given of a wireless communication base station device according to a third embodiment of the present embodiment. The present embodiment corresponds to the first embodiment in which the wireless LAN terminal having failed in the shift is detected by a method different from that shown in FIG. 6 and FIG. 9, described in the second embodiment. Thus, the configuration and general operation of the access point 2 are similar to those in the first embodiment and will thus not be described. Only differences from the first embodiment will be described below.

The method according to the present embodiment first transmits a data frame in accordance with the second communication scheme in expectation of a response frame. If the response frame for the data frame cannot be received, the BAR frame, requesting the response frame for the already transmitted data frame, is transmitted in accordance with the first communication scheme. If the response frame for the data frame cannot be received and the BA frame has been received in response to the BAR frame, the wireless LAN terminal is determined to have failed in the shift.

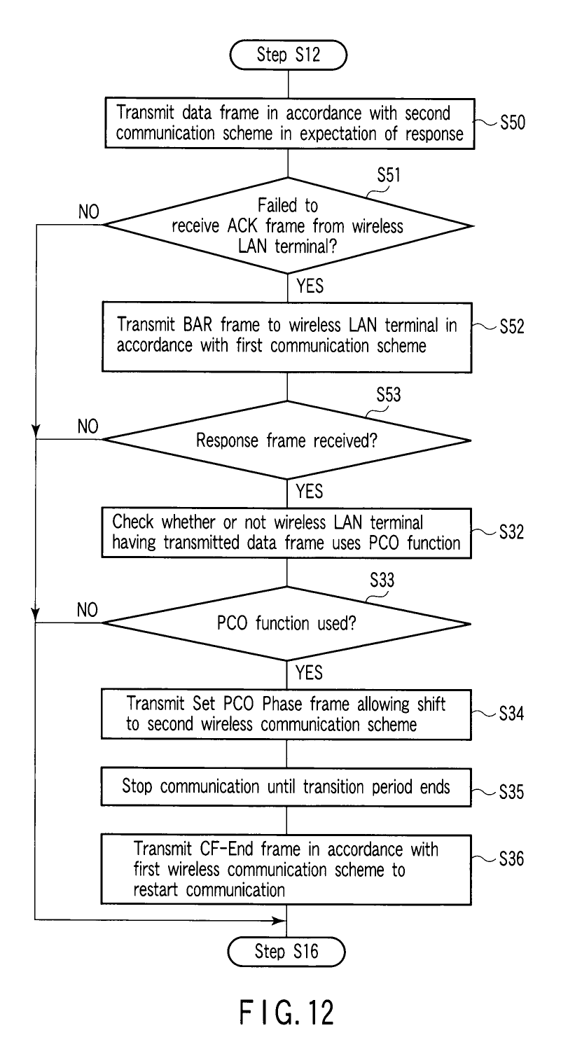

FIG. 12 is a flowchart showing the details of step S30 in FIG. 5. As shown in FIG. 12, after steps S10 to S12, described in the first embodiment, the data frame transmitting section 34 of the access point 2 transmits a data frame to one of the wireless LAN terminals in accordance with the second communication scheme in expectation of a response (step S50). Subsequently, the shift failing terminal detecting section 33 monitors whether or not the control frame receiving section 38 has received the response frame for the data frame transmitted in step S50.

If the response frame has been received (step S51, NO), the shift failing terminal detecting section 33 determines that the wireless LAN terminal has not failed in the shift. The process proceeds to step S16. If the response frame has not been received (step S51, YES), the data frame transmitted in step S50 is retransmitted in expectation of a response or the BAR frame, requesting a response, is transmitted to the wireless LAN terminal 3 in accordance with the first communication scheme (step S52).

The shift failing terminal detecting section 33 then monitors whether or not the control frame receiving section 38 has received the BA frame for the BAR frame transmitted in step S52. If the BA frame has not been received (step S53, NO), the process proceeds to step S16. If the BA frame has been received (step S53, YES), the wireless LAN terminal has responded to the frame transmitted in accordance with the first communication scheme but not to the frame transmitted in accordance with the second communication scheme. Thus, at this point in time, the wireless LAN terminal is determined to be still operating in accordance with the first communication scheme.

Then, the shift failing terminal detecting section 33 checks whether or not the wireless LAN terminal 3 or 4 uses the PCO function (step S32). Then, the process following step S33, described in the first embodiment with reference to FIG. 6, is executed.

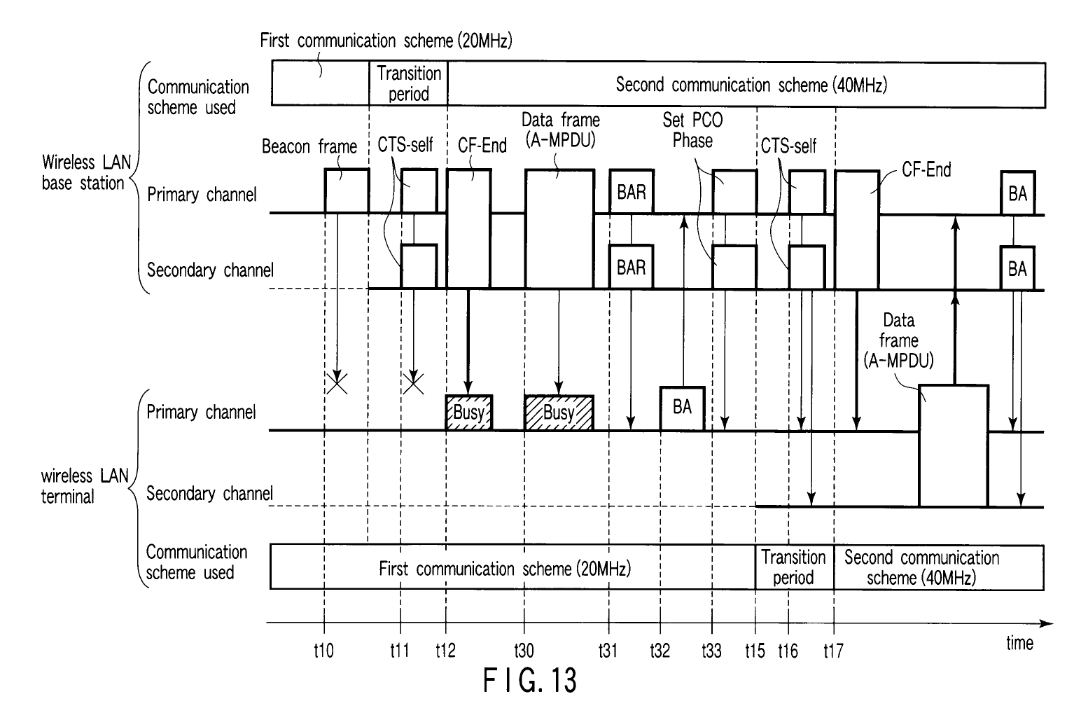

Now, with reference to FIG. 13, description will be given of a specific example of the operation described with reference to FIG. 12, focusing on the shift from the first communication scheme to the second communication scheme. FIG. 13 is a time chart showing how frames are transmitted and received between the access point 2 and the wireless LAN terminal 3.

As shown in FIG. 13, the operation performed until the time t12, when the access point 2 transmits the CF-End frame, is similar to that shown in FIG. 7, described in the first embodiment. Since the CF-End frame is transmitted in accordance with the second communication scheme, NAV is cleared only for the wireless LAN terminal 3 having successfully shifted to the second communication scheme. Data transmission and reception is started in accordance with the second communication scheme. However, the wireless LAN terminal 3 having failed in the shift is still operating in accordance with the first communication scheme and cannot transmit or receive data in accordance with the second communication scheme.

Then, in the access point 2, the data frame transmitting section 34 transmits the A-MPDU frame to one of the wireless LAN terminals 3 in accordance with the second communication scheme in expectation of a response frame (at a time t30). The shift failing terminal detecting section 33 monitors the control frame receiving section 38 to determine whether or not the control frame receiving section 38 has received the response frame from the wireless LAN terminal 3. However, the wireless LAN terminal 3 is communicating in accordance with the first communication scheme and thus cannot receive this frame. The shift failing terminal detecting section 33 can thus only recognize a band busy status in which noise is present on the transmission path. Consequently, the wireless LAN terminal 3 does not return the response frame. The shift failing terminal detecting section 33 recognizes that the response frame has not been successfully received.

Then, since the BA frame has not been successfully received in response to the A-MPDU frame, the wireless LAN base station 2 allows the control frame transmitting section 35 to transmit the BAR frame, requesting the BA frame, on both the primary channel and the secondary channel in accordance with the first communication scheme (at a time t31). The BAR frame may be transmitted only on the primary channel in accordance with the first communication scheme. Furthermore, the shift failing terminal detecting section 33 monitors the control frame receiving section 38 to check whether or not the BA frame is received in response to the BAR frame.

The wireless LAN terminal 3 still operating in accordance with the first communication scheme can receive the BAR frame transmitted in accordance with the first communication scheme. Thus, in response to the BAR frame, the wireless LAN terminal 3 returns the BA frame to the access point 2 on the primary channel in accordance with the first communication scheme (at a time t32). The contents of the acknowledge information accompanying the BA frame received at this point in time indicate that none of the data frames contained in the A-MPDU frame transmitted at the time t30 have been successfully received.

Upon receiving the BA frame, the shift failing terminal detecting section 33 determines that the wireless LAN terminal 3 is communicating in accordance with the first communication scheme. Thus, the shift failing terminal detecting section 33 checks whether or not the wireless LAN terminal 3 uses the PCO function. Upon determining that the wireless LAN terminal 3 uses the PCO function, the shift failing terminal detecting section 33 further determines that the wireless LAN terminal 3 has failed in the shift.

The shift failing terminal detecting section 33 thus commands the switching instruction frame transmitting section 36 to transmit the Set PCO Phase frame again. Thus, at a time t33, the access point 2 simultaneously transmits the Set PCO Phase frame on both the primary channel and the secondary channel to command the terminal again to shift to the second communication scheme.

The operation performed after the time t15 is similar to that in the first embodiment.

As described above, the wireless communication system according to the third embodiment of the present invention exerts an effect (3).

(3) The Data Transmission Efficiency can be Improved (3).

The wireless communication system according to the present embodiment uses a method described below to detect the wireless LAN terminal having failed to shift from the first communication scheme to the second communication scheme.

The shift failing terminal detecting section 33 monitors whether or not the response frame has been received in response to the data frame transmitted in accordance with the second communication scheme. Moreover, if the response frame has not been received, the shift failing terminal detecting section 33 monitors whether or not the BA frame has been received in response to the BAR frame transmitted to the wireless LAN terminal 3. If the wireless LAN terminal, not having transmitted the response frame for the data frame but having transmitted the BA frame in response to the BAR frame, uses the PCO function, the shift failing terminal detecting section 33 determines that the wireless LAN terminal has failed in the shift. This is because the wireless LAN terminal cannot receive the frame transmitted in accordance with the second communication scheme but can receive the frame transmitted in accordance with the first communication scheme, meaning that the wireless LAN terminal is still communicating in accordance with the first communication scheme.

The shift command is then transmitted again to the wireless LAN terminal 3 having failed in the shift to rescue the wireless LAN terminal 3. This makes it possible to exert an effect similar to the effect (1), described in the first embodiment. Furthermore, the transmission of the BAR frame is commonly performed if no response frame has been obtained as a result of the transmission of a data frame. This eliminates the need to, for example, transmit a new frame only to detect a shift failing terminal, allowing the shift failing terminal to be easily detected.

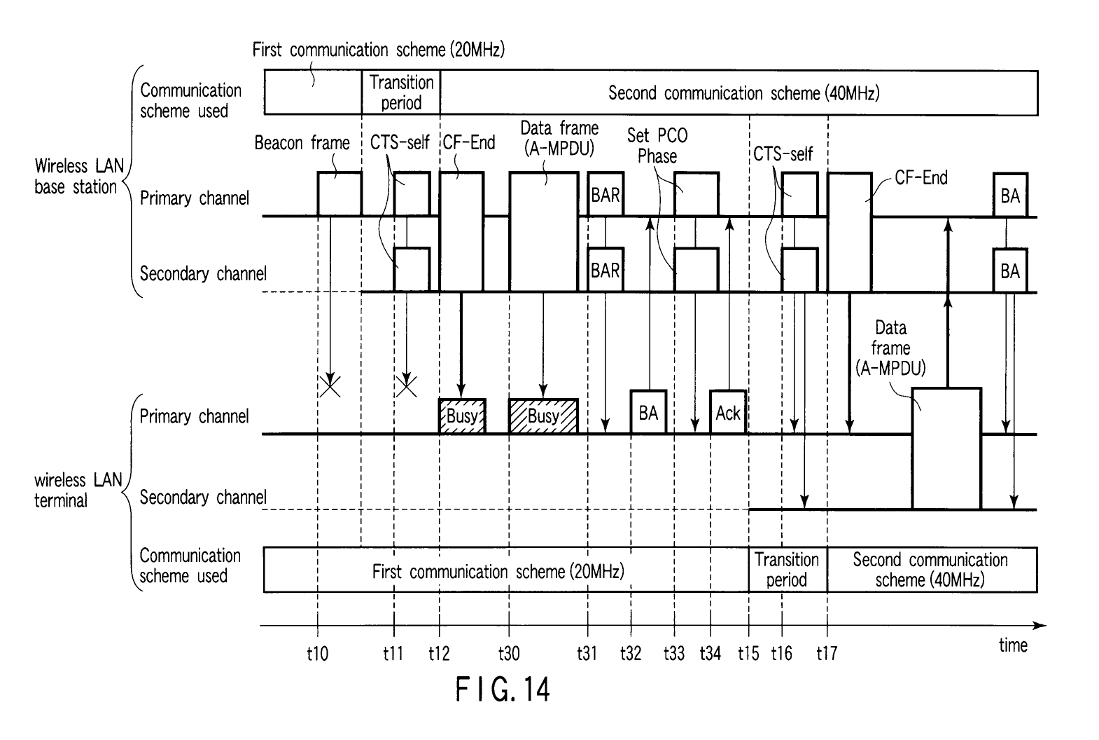

Of course, also in the present embodiment, the access point 2 may transmit the Set PCO Phase frame as a unicast frame. FIG. 14 is a time chart showing how frames are transmitted and received between the access point 2 and the wireless LAN terminal 3 when the access point 2 transmits the Set PCO Phase frame as a unicast frame. As shown in FIG. 14, by transmitting the Set PCO Phase frame as a unicast frame at the time t33, it is possible to obtain the ACK frame at a time t34.

As described above, the wireless LAN base station device according to the first to third embodiments of the present invention attempts to detect a wireless LAN terminal having failed to shift from the 20-MHz band communication to the 40-MHz band communication. If such a wireless LAN terminal has been detected, the wireless LAN base station device transmits the shift command again. This makes it possible to prevent the wireless LAN terminal having failed to shift to the 40-MHz band communication from being disabled to communicate during the 40-MHz band communication period.

Moreover, the wireless LAN terminal having failed in the shift performs the 20-MHz band communication during the 40-MHz band communication period, inefficiently occupying the frequency bands. However, the present embodiment can avoid the inefficient band occupation, allowing the whole BSS managed by the wireless LAN base station to efficiently utilize the frequency bands.

In the above-described embodiments, by way of example, the wireless LAN system uses the two communication schemes that use the 20- and 40-MHz transmission bands, respectively. However, the transmission bands are not limited to 20 MHz and 40 MHz. The above embodiments are also applicable to a wireless LAN system that uses a mixture of at least three communication schemes.

Furthermore, the shift failing terminal detecting section 33 may be realized by software to execute the processes shown in FIGS. 6, 9, and 12 using, for example, a CPU or may be realized by hardware.

Moreover, the first to third embodiments may be combined together. That is, in the first embodiment, an attempt is made to detect a shift failing terminal when data has been transmitted by the wireless LAN terminal 3. In contrast, in the second and third embodiments, an attempt is made to detect a shift failing terminal when the wireless LAN base station 2 transmits the RTS frame and when the wireless LAN base station transmits the data frame. However, the first and second embodiments may be combined together or the first and third embodiments may be combined together. Of course, the first to third embodiments may all be combined together. These combinations enable an increase in the number of opportunities of detecting a shift failing terminal.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless communication base station device allowing use of a first wireless communication scheme and a second wireless communication scheme, the device comprising:
a command transmitting section which generates a shift command for a shift from the first wireless communication scheme to the second wireless communication scheme and which transmits the shift command to a wireless communication terminal, the first wireless communication scheme using a frequency bandwidth different from that used in the second wireless communication scheme; and
a terminal detecting section which, after the transmission of the shift command, searches for a wireless communication terminal having failed to shift from the first wireless communication scheme to the second wireless communication scheme and which, if the wireless communication terminal having failed in the shift is detected, instructs the command transmitting section to transmit the shift command again.

2. The device according to claim 1, further comprising a receiving section configured to receive a frame transmitted by the wireless communication terminal in accordance with the first communication scheme,
wherein when the receiving section receives the frame transmitted in accordance with the first wireless communication scheme after the transmission of the shift command, the terminal detecting section determines that a wireless communication terminal having transmitted the frame has failed to shift to the second wireless communication scheme.

3. The device according to claim 2, wherein the frame includes a plurality of aggregated single frames.

4. The device according to claim 1, further comprising a frame transmitting section which, after the transmission of the shift command, transmits a first frame the wireless communication terminal in accordance with the first wireless communication scheme in expectation of a first response frame and which, after the transmission of the first frame, transmits a second frame to the wireless communication terminal in accordance with the second wireless communication scheme in expectation of a second response frame; and
a receiving section configured to receive the first response frame and the second response frame,
wherein the terminal detecting section determines that the wireless communication terminal from which the receiving section has received the first response frame but not received the second response frame has failed to shift to the second wireless communication scheme.

5. The device according to claim 4, wherein the first frame is a control frame, and
the second frame includes a plurality of aggregated single frames.

6. The device according to claim 1, further comprising a frame transmitting section which, after the transmission of the shift command, transmits a first frame to the wireless communication terminal in accordance with the second wireless communication scheme in expectation of a first response frame and which, after the transmission of the first frame, transmits a second frame to the wireless communication terminal in accordance with the first wireless communication scheme in expectation of a second response frame; and
a receiving section configured to receive the first response frame and the second response frame,
wherein the terminal detecting section determines that the wireless communication terminal from which the receiving section has received the second response frame but not received the first response frame has failed to shift to the second wireless communication scheme.

7. The device according to claim 6, wherein the first frame includes a plurality of aggregated single frames, and
the second frame requests a response to the first frame.

8. The device according to claim 1, wherein the terminal detecting section instructs the command transmitting section to retransmit the shift command to the wireless communication terminal which is determined to have failed to shift to the second wireless communication scheme and which is specified as a destination.

9. The device according to claim 8, wherein in retransmitting the shift command, the terminal detecting section transmits a frame in expectation of a response frame from the wireless communication terminals.

10. The device according to claim 1, wherein the first wireless communication scheme uses a 20-MHz frequency bandwidth, and the second wireless communication scheme uses a 40-MHz frequency bandwidth.

11. A wireless communication method comprising:
transmitting a shift command for a shift from a first wireless communication scheme to a second wireless communication scheme to a wireless communication terminal, the first wireless communication scheme using a frequency bandwidth different from that used in the second wireless communication scheme;
after the transmission of the shift command, searching for a wireless communication terminal having failed to shift from the first wireless communication scheme to the second wireless communication scheme; and
if the wireless communication terminal having failed to shift to the second wireless communication scheme is detected, transmitting the shift command again.

12. The method according to claim 11, wherein when a frame is received from the wireless communication terminal in accordance with the first wireless communication scheme after the transmission of the shift command, the wireless communication terminal is determined to have failed to shift to the second wireless communication scheme.

13. The method according to claim 12, wherein the frame includes a plurality of aggregated single frames.

14. The method according to claim 11, wherein the search for the wireless communication terminal includes
after the transmission of the shift command, transmitting a first frame to the wireless communication terminal in accordance with the first wireless communication scheme in expectation of a first response frame;
if the first response frame has been received from the wireless communication terminal, transmitting a second frame to the wireless communication terminal in accordance with the second wireless communication scheme in expectation of a second response frame; and
if the second response frame has not been received from the wireless communication terminal, making determination that the wireless communication terminal has failed to shift to the second wireless communication scheme.

15. The method according to claim 14, wherein the first frame is a control frame, and
the second frame includes a plurality of aggregated single frames.

16. The method according to claim 11, wherein the search for the wireless communication terminal includes
after the transmission of the shift command, transmitting a first frame to the wireless communication terminal in accordance with the second wireless communication scheme in expectation of a first response frame;
if the first response frame has not been received from the wireless communication terminal, transmitting a second frame to the wireless communication terminal in accordance with the first wireless communication scheme in expectation of a second response frame; and
if the second response frame has been received from the wireless communication terminal, making determination that the wireless communication terminal has failed to shift to the second wireless communication scheme.

17. The method according to claim 16, wherein the first frame includes a plurality of aggregated single frames, and
the second frame requests a response to the first frame.

18. The method according to claim 11, wherein the shift command to be retransmitted is transmitted to the wireless communication terminal which is determined to have failed to shift to the second wireless communication scheme and which is specified as a destination.

19. The method according to claim 18, wherein the shift command to be retransmitted is transmitted using a frame in expectation of a response frame from the wireless communication terminals.

20. The method according to claim 11, wherein the first wireless communication scheme uses a 20-MHz frequency bandwidth, and the second wireless communication scheme uses a 40-MHz frequency bandwidth.
